(19) United States
(12) Patent Application Publication
(10) Pub. No.: US 2011/0006996 A1
(43) Pub. Date: Jan. 13, 2011

(54) PRIVATE DATA ENTRY

(76) Inventors: Nathan J. Smith, Oxford (GB); Alistair P. Curd, High Wycombe (GB); Matti P. T. Juvonen, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/499,233

(22) Filed: Jul. 8, 2009

(51) Int. Cl. G06F 3/041; G06F 3/02; G06F 3/01

(52) U.S. Cl. 345/173; 345/168; 715/702

(57) ABSTRACT

A device and method for creating a private entry display on a touchscreen is provided, wherein the touchscreen includes a plurality of touch cells corresponding to spatial locations on the touchscreen. A graphical user interface is generated for display on the touchscreen for a predefined operation, the graphical user interface including a plurality of input zones. A characteristic of the graphical user interface as displayed on the touchscreen for the predefined operation is alter in order to change the touch cells associated with the graphical user interface. The altered user interface then is displayed on the touchscreen.

### TECHNICAL FIELD

The invention relates to a display on which data of a confidential nature, for example, a Personal Identification Number (PIN), is entered. Such a display may be used, for example, in a cashpoint (ATM), a payment terminal, a laptop personal computer, a desktop monitor, a public information display, etc. The display and related methods described herein prevent third parties from deducing data input by the user.

### BACKGROUND OF THE INVENTION

“Shoulder Surfing” is the act of third party spying in order to determine data entered by a user. Shoulder Surfing is most commonly used by criminals to determine the Personal Identification Number (PIN) of cashpoint (ATM) users and of payment terminal users. The criminal is able to determine a user's PIN in one of two ways:
1) The user's button presses (keystrokes) on a numerical keypad are seen directly; or
2) The pattern of the user's button presses (keystrokes) is noted and this pattern is used to determine the PIN. Determination of a PIN via keystroke pattern recognition is made possible since numerical keypads have a standard arrangement of keys and the size, shape and position of the keypad is also constant.

The use of a display with a privacy function and a touchscreen for data input can be used to circumvent problem 1 (i.e., a third party is unable to directly view a user's keystrokes on a numerical keypad shown on the display). The display type may be, for example, an LCD, OLED, CRT, plasma, etc. The privacy function on the display may be achieved, for example, using a louvre, software processing, an additional LCD, an arrangement of lenses, a parallax barrier arrangement, an arrangement of parallax barrier and lenses, etc. The privacy function, for example, may be switchable between a public wide view mode and private narrow view mode. The privacy function, for example, may be fixed so that just a private mode is realised. The touchscreen on the display, for example, may be a resistive type, a capacitive type, an optical sensor that is either intrinsic to the display (such as a photodiode array) or extrinsic to the display (such as 1 or more camera modules).

The use of a display with a privacy function and a touchscreen for data input prevents third parties from directly viewing a user's PIN. However, third parties can still interpret a PIN via the pattern of keystrokes made by a user if the keypad has a standard arrangement of keys and the size, shape and position of the keypad is also constant.

GB2422355B2, GB2422353B2 and WO06077581A3 describe the use of a retractable screen for use with a numerical keypad to enable private data entry of a PIN. The retractable screen requires activation by the user and consequently does not automatically provide privacy from third parties.

GB2422135A describes the use of a privacy shield to be worn by the user for private data entry of a PIN. The privacy shield obscures third parties from determining the PIN entry. However, the privacy shield also obscures the user from viewing PIN entry and consequently the device would not be widely acceptable since many users need to look at the keypad in order to successfully enter their PIN. In addition, the privacy shield is not an automatic privacy method which also prevents wide user acceptability.

U.S. Pat. No. 6,543,684 describes the use of a privacy shield to be used in conjunction with a numerical keypad for private data entry of a PIN. The privacy shield obscures the user from viewing PIN entry to some extent and consequently the device would not be widely acceptable since many users need to look at the keypad in order to successfully enter their PIN.

WO02100016A1, U.S. Pat. No. 7,395,506 and U.S. Pat. No. 7,296,233 describe methods of generating a non-standard numerical keypad layout in order to achieve private data entry. The non-standard keypad layout prevents third parties from inferring a PIN via the pattern of keystrokes performed by the user and consequently a private data entry method is realised. However, many people remember their PIN via the pattern of keystrokes made on a standard numerical keypad. Consequently, this method for private data entry would not be widely acceptable since many users would not be able to recall their PIN when confronted with a non-standard numerical keypad.

Kumar, Garfinkel, Boneh and Winograd (Stanford University, Stanford, Calif., USA) describe a method for private data entry in their paper “Reducing shoulder-surfing by using gaze-based password entry” (ACM International Conference Proceeding Series; Vol. 229, Proceedings of the 3rd symposium on Usable privacy and security). The method requires the user to input a PIN or password by gazing at the sequence of letters or numbers displayed upon the screen. A camera system detects the user's gaze directions and interprets the PIN or password. This system would not have wide user acceptability since the system could not be used when the user is wearing sun glasses, motorbike visor etc. The system would also not work for users with medical eye conditions, such as Amblyopia (lazy eye) etc.

### SUMMARY OF THE INVENTION

When a display with a privacy function and a touchscreen input is used in conjunction with a novel method for displaying a standard keypad layout, problem 2 described above can be circumvented (i.e., a third party is unable to interpret a user's PIN via the pattern of keystrokes performed). The method of displaying the standard keypad layout in accordance with the present invention, for example, may involve changing the size of the keypad displayed, changing the shape of the keypad displayed, changing the position of the keypad displayed and/or displaying more than one standard keypad simultaneously. If more than one standard keypad is displayed simultaneously, one or more of the keypads may be used for active data entry. The method of displaying the standard keypad layout, for example, may change for each user, change between one, or more than one, keystroke, and/or may be predefined and specific to each user.

The method and apparatus in accordance with the invention allows for automatic private data entry using a standard keypad layout. Consequently, the user does not have to remember to activate the private data entry function. The use of a standard keypad layout is advantageous since many people remember their PIN via the pattern of keystrokes made on a standard keypad layout. The method of private data entry in accordance with the invention is advantageous since it would be very easy to use and does not require the user to perform non-standard actions. The method of private data entry described is so closely related to standard, non-private data entry methods that users may be unaware that an added security feature has been introduced. A system that adds an appreciable level of security for data entry while being virtually invisible to the user is advantageous for wide acceptability. The method of private data entry in accordance with the invention is advantageous since it does not discriminate against users with physical and/or mental health problems.

According to one aspect of the invention, a device for privately entering data includes: a touchscreen having a plurality of touch cells for inputting data; a processor section configured to generate a graphical user interface for display on the touchscreen for a predefined operation, the graphical user interface including a plurality of input zones; and a privacy section operatively coupled to the processor section and to the touchscreen, the privacy section configured to alter a characteristic of the graphical user interface as displayed on the touchscreen for the predefined operation in order to change the touch cells associated with the graphical user interface.

According to one aspect of the invention, the graphical user interface is a key pad.

According to one aspect of the invention, the privacy section is configured to vary a spatial location of the user interface on the touchscreen.

According to one aspect of the invention, the privacy section is configured to vary an aspect ratio of each input zone.

According to one aspect of the invention, the privacy section is configured to form a width of each input zone to be greater than a height of each input zone.

According to one aspect of the invention, the privacy section is configured to form a height of each input zone to be greater than a width of each input zone.

According to one aspect of the invention, the privacy section is configured to form at least one of non-uniform height or non-uniform width between at least two input zones of the plurality of input zones.

According to one aspect of the invention, the privacy section is configured to generate a plurality of user interfaces having the same input zones, the plurality of user interfaces arranged such that when displayed on the touchscreen each input zone of the respective plurality of user interfaces corresponds to a different touch cell of the touchscreen.

According to one aspect of the invention, a device for privately entering data includes: a touchscreen having a plurality of touch cells for inputting data; a privacy section configured to generate a plurality of graphical user interfaces for entering the private data, each graphical user interface comprising substantially the same input functions; and a display section configured to simultaneously display the multiple graphical user interfaces on the touchscreen.

According to one aspect of the invention, the plurality of user interfaces are graphically different from one another.

According to one aspect of the invention, the privacy section is configured to select different ones of the plurality of user interfaces for each data entry.

According to one aspect of the invention, the privacy section is configured to vary a location of the user interface on the touchscreen after each data entry.

According to one aspect of the invention, altering the graphical user interface includes at least one of randomly altering the user interface, altering the user interface based on user identity, altering the user interface based on user preference, or altering the user interface based on operator preference.

According to one aspect of the invention, the privacy section is configured to change at least one of a size, shape, or position of the user interface between at least two data entries on the touchscreen.

According to one aspect of the invention, the touchscreen comprises a privacy device that prevents viewing of the screen at an angle greater than a predetermined angle normal to a surface of the touchscreen.

According to one aspect of the invention, the processor section configures the plurality of input zones to correspond to a first group of touch cells of the plurality of touch cells, and the privacy section reconfigures the input zones to correspond to a second group of touch cells of the plurality of touch cells, the second group of touch cells different from the first group of touch cells.

According to one aspect of the invention, a method for creating a private entry display on a touchscreen, said touchscreen including a plurality of touch cells corresponding to spatial locations on the touchscreen, the method including: generating a graphical user interface for display on the touchscreen for a predefined operation, the graphical user interface including a plurality of input zones; altering a characteristic of the graphical user interface as displayed on the touchscreen for the predefined operation in order to change the touch cells associated with the graphical user interface; and displaying the altered user interface on the touchscreen.

According to one aspect of the invention, generating a graphical user interface includes generating the graphical user interface as a key pad.

According to one aspect of the invention, altering the characteristic of the graphical user interface includes varying a spatial location of the user interface on the touchscreen.

According to one aspect of the invention, altering characteristic of the graphical user interface includes varying an aspect ratio of each input zone.

According to one aspect of the invention, varying an aspect ratio of each input zone includes forming a width of each input zone to be greater than a height of each input zone.

According to one aspect of the invention, varying an aspect ratio of each input zone includes forming a height of each input zone to be greater than a width of each input zone.

According to one aspect of the invention, altering the characteristic of the graphical user interface includes varying at least one of an input zone width or an input zone height between at least two input zones of the plurality of input zones.

According to one aspect of the invention, altering the characteristic of the graphical user interface includes creating a plurality of user interfaces having the same input zones, and displaying each of the plurality of user interfaces on different portions of the touchscreen such that each input zone of the respective plurality of user interfaces corresponds to a different touch cell of the touchscreen.

According to one aspect of the invention, a method for entering private data on a touchscreen, said private data including at least two input data, the method including: generating a plurality of graphical user interfaces for entering the private data, each graphical user interface comprising substantially the same input functions; simultaneously displaying the plurality of graphical user interfaces on the touchscreen; using the input function of one of the plurality of graphical user interfaces to enter one of the at least two input data; and using the input function of a different one of the plurality of graphical user interfaces to enter the other of the at least two input data.

According to one aspect of the invention, the method further includes generating the plurality of user interfaces such that they are different from one another.

According to one aspect of the invention, the method further includes entering data on different ones of the plurality of user interfaces.

According to one aspect of the invention, the method further includes varying a location of the user interface on the touchscreen after each data entry.

According to one aspect of the invention, the method further includes changing at least one of a size, shape, or position of the user interface between at least two data entries on the touchscreen.

According to one aspect of the invention, the method further includes preventing the screen from being viewed at an angle greater than a predetermined angle normal to a surface of the touchscreen.

According to one aspect of the invention, altering the characteristic of the graphical user interface includes at least one of randomly selecting the attribute to be altered, selecting the attribute to be altered based on a user identification, selecting the attribute to be altered based on a pre-defined user preference, or selecting the attribute to be altered based on a pre-defined operator preference.

According to one aspect of the invention, generating the graphical user interface includes configuring the plurality of input zones to correspond to a first group of touch cells of the plurality of touch cells, and wherein altering the characteristic of the graphical user interface includes reconfiguring the input zones to correspond to a second group of touch cells of the plurality of touch cells, the second group of touch cells different from the first group of touch cells.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 shows a layout of a conventional numerical keypad.

FIG. 2 shows the conventional numerical keypad of FIG. 1 displayed on an information display.

FIG. 3 shows a touchscreen and a privacy function in accordance with an embodiment of the invention.

FIG. 4 shows a touchscreen and a privacy function in accordance with another embodiment of the invention.

FIG. 5 shows a touchscreen and a privacy function in accordance with another embodiment of the invention.

FIG. 6 shows a touchscreen and a privacy function in accordance with another embodiment of the invention.

FIG. 7 shows a touchscreen and a privacy function in accordance with another embodiment of the invention.

FIG. 8 shows a touchscreen and a privacy function in accordance with another embodiment of the invention.

FIG. 9 shows a touchscreen and a privacy function in accordance with another embodiment of the invention.

FIG. 10 shows a touchscreen and a privacy function in accordance with another embodiment of the invention.

FIG. 11 shows a touchscreen and a privacy function in accordance with another embodiment of the invention.

FIG. 12 shows a touchscreen and a privacy function in accordance with another embodiment of the invention.

FIG. 13 shows a touchscreen and a privacy function in accordance with another embodiment of the invention.

FIG. 14a shows a touchscreen and a privacy function in accordance with another embodiment of the invention.

FIG. 14b shows a touchscreen and a privacy function in accordance with the embodiment of FIG. 14a.

FIG. 14c shows a touchscreen and a privacy function in accordance with the embodiment of FIG. 14a.

FIG. 14d shows a touchscreen and a privacy function in accordance with the embodiment of FIG. 14a.

FIG. 15 shows a block diagram of an exemplary device for carrying out a privacy function in accordance with the invention.

### DETAILED DESCRIPTION OF THE INVENTION

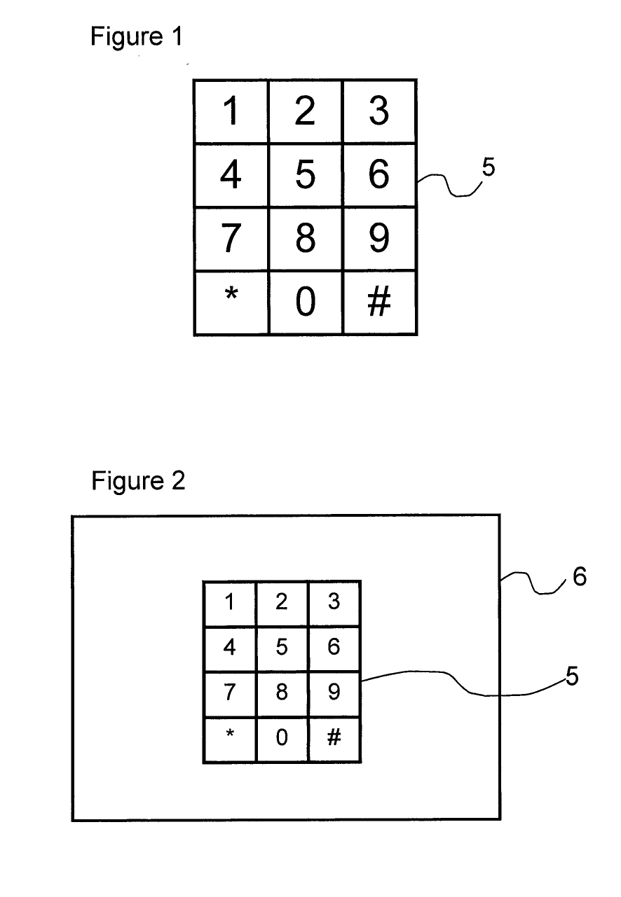

A standard keypad 5 for numerical data entry is shown in FIG. 1. The standard keypad 5 includes an array 3 keys wide and 4 keys high. The arrangement of numbered keys on the standard keypad 5 is fixed (i.e., key number “5” always has key number “2” above, key number “8” below, key number “4” to the left and key number “6” to the right. A standard keypad has keys representing the numbers “1”, “2” and “3” on the uppermost line, keys representing the numbers “4”, “5” and “6” on the line immediately below the uppermost line, and keys representing the numbers “7”, “8” and “9” on the line immediately above the lowermost line. A standard keypad also has keys representing the alphanumeric characters “*”, “0” and “#” on the lowermost line.

FIG. 2 shows a standard keypad 5 displayed upon an information display 6. The information display 6 may be a Liquid Crystal Display (LCD), Organic Light Emitting Display (OLED), Plasma Display Panel (PDP), Cathode Ray Tube (CRT) etc. The display 6 has a privacy function and a touchscreen for data input. The privacy function on the display 6 may be achieved, for example, using a louvre, software processing, an additional LCD, an arrangement of lenses, a parallax barrier arrangement, an arrangement of parallax barrier and lenses, etc. The privacy function on the display 6, for example, may be switchable between a public wide view mode (i.e., the information on the display are discernable for a wide range of viewing angles) and a private narrow view mode (i.e., the information on the display are discernable for a narrower range of viewing angles than the public mode). The privacy function on the display 6, for example, may be fixed so that just a private mode is realised. The display 6 is capable of registering the position of a touch event, i.e., the display 6 is equipped with a touchscreen. The touchscreen on the display, for example, may be a resistive type, a capacitive type, an optical sensor that is intrinsic to the display (such as a photodiode array) or an optical sensor that is extrinsic to the display (such as one or more camera modules). The touchscreen may accept sequential single touch events. The touchscreen may accept multiple simultaneous touch events.

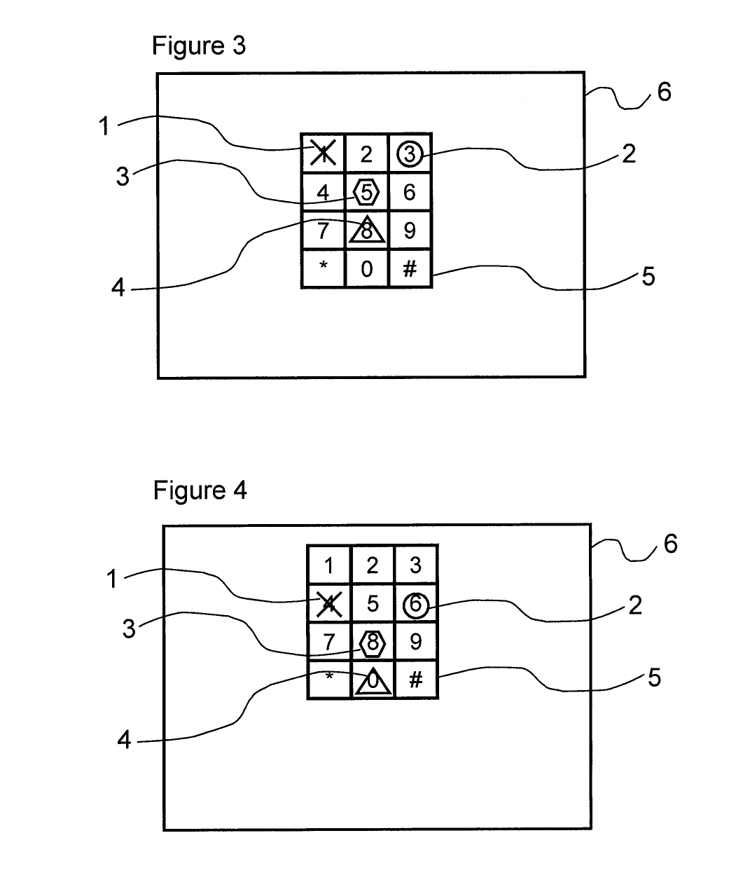

FIGS. 3 and 4 show a standard keypad 5 displayed on an information display 6 that has a touchscreen and a privacy function in accordance with an embodiment of the invention. The individual keys on keypad 5 have uniform height and uniform width, and each individual key on keypad 5 has an aspect ratio whereby the key width is equal to key height. FIG. 3 shows four sequential touch events on a standard keypad 5. The touch events 1 to 4 are denoted by a cross 1, a circle 2, a hexagon 3 and a triangle 4. Consequently, the Personal Identification Number (PIN) associated with FIG. 3 is “1358”. FIG. 4 shows four sequential touch events on a standard keypad 5. The touch events 1 to 4 are denoted by a cross 1, a circle 2, a hexagon 3 and triangle 4. Consequently, the Personal Identification Number (PIN) associated with FIG. 4 is “4680”.

By comparing FIG. 3 and FIG. 4, it is clear that the spatial positions of the touch events in FIG. 3 and FIG. 4 are identical relative to the display 6 but the resulting PIN entered in FIG. 3 and FIG. 4 is different. The display 6 is equipped with a privacy function in accordance with an embodiment of the invention that prevents third parties from directly viewing the keystrokes of a PIN. However, if the keypad position has a fixed location on the display 6 a third party is able to deduce the PIN entered via the pattern of keystrokes used. As demonstrated by FIG. 3 and FIG. 4, by moving the keypad 5 to different spatial locations on the display 6, a third party is not able to unambiguously discern the PIN entered via the pattern keystrokes.

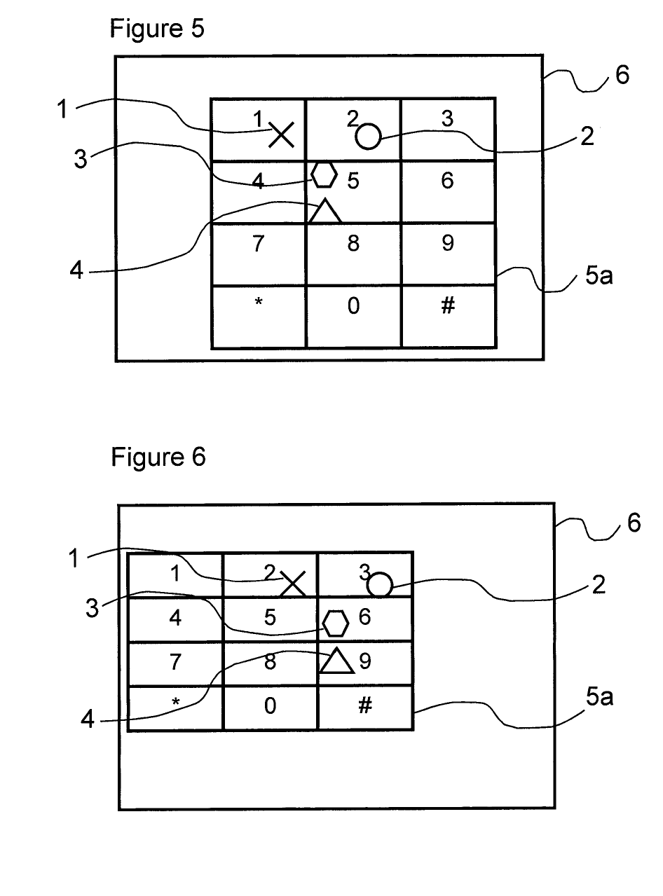

FIG. 5 shows a keypad 5a displayed on an information display 6 that has a touchscreen and a privacy function in accordance with another embodiment of the present invention. The keypad 5a in FIG. 5 has a standard arrangement of keys, wherein the individual keys on keypad 5 a have uniform height and uniform width. The individual keys on keypad 5a have an aspect ratio whereby the key width is greater than the key height. FIG. 5 shows four sequential touch events on a keypad 5a, wherein the touch events 1 to 4 are denoted by a cross 1, a circle 2, a hexagon 3 and triangle 4. Consequently, the Personal Identification Number (PIN) associated with FIG. 5 is “1255”. Relative to the display 6, the spatial positions of the touch events in FIG. 5 and FIG. 3 are identical but the resulting PIN entered in FIG. 5 and FIG. 3 is different. As demonstrated by FIG. 3 and FIG. 5, by changing the shape and size of a keypad with a standard arrangement of keys, a third party is not able to unambiguously discern the PIN entered via the pattern of keystrokes.

FIG. 6 shows a keypad 5a displayed on an information display 6 that has a touchscreen and a privacy function in accordance with another embodiment of the present invention. The keypad 5a in FIG. 6 has a standard arrangement of keys. The individual keys on keypad 5a have uniform height and uniform width, and the individual keys on keypad 5a have an aspect ratio whereby the key width is greater than the key height. FIG. 6 shows four sequential touch events on a keypad 5a. The touch events 1 to 4 are denoted by a cross 1, a circle 2, a hexagon 3 and triangle 4. Consequently, the Personal Identification Number (PIN) associated with FIG. 6 is “2369”. Relative to the display 6, the spatial positions of the touch events in FIG. 6 and FIG. 3 are identical but the resulting PIN entered in FIG. 6 and FIG. 3 is different. As demonstrated by FIG. 3 and FIG. 6, by changing the shape, size and/or location of a keypad with a standard arrangement of keys, a third party is not able to unambiguously discern the PIN entered via the pattern of keystrokes.

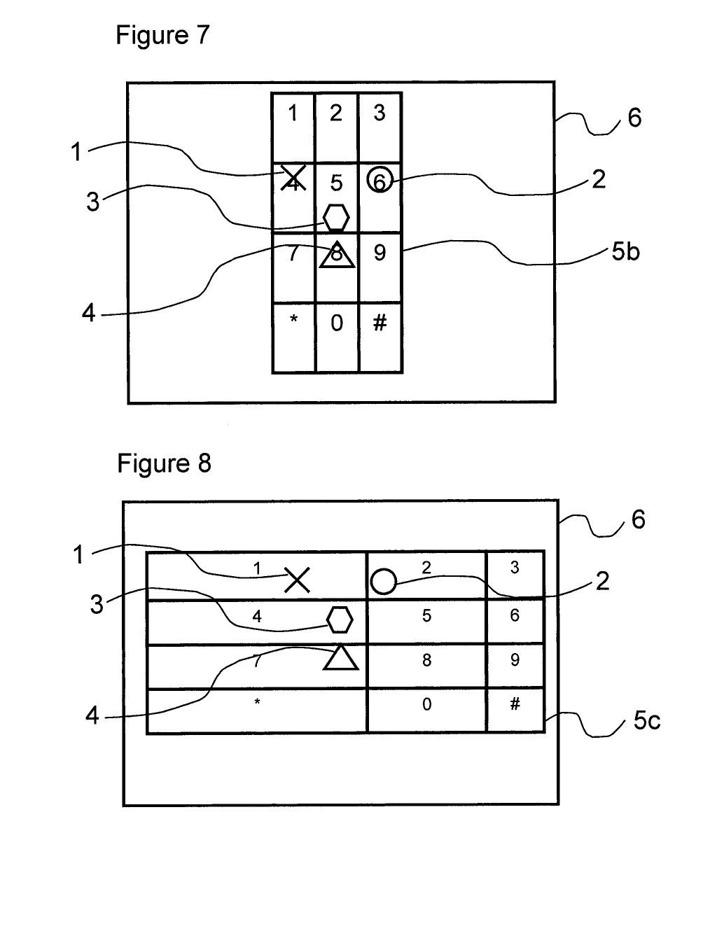

FIG. 7 shows a keypad 5b displayed on an information display 6 that has a touchscreen and a privacy function in accordance with another embodiment of the present invention. The keypad 5b in FIG. 7 has a standard arrangement of keys, and the individual keys on keypad 5b have uniform height and uniform width. The individual keys on keypad 5b have an aspect ratio whereby the key height is greater than the key width. FIG. 7 shows four sequential touch events on a keypad 5b. The touch events 1 to 4 are denoted by a cross 1, a circle 2, a hexagon 3 and triangle 4. Consequently, the Personal Identification Number (PIN) associated with FIG. 7 is “4658”. Relative to the display 6, the spatial positions of the touch events in FIG. 7 and FIG. 3 are identical but the resulting PIN entered in FIG. 7 and FIG. 3 is different. As demonstrated by FIG. 3 and FIG. 7, by changing the shape and size of a keypad with a standard arrangement of keys, a third party is not able to unambiguously discern the PIN entered via the pattern of keystrokes.

FIG. 8 shows a keypad 5c displayed on an information display 6 that has a touchscreen and a privacy function in accordance with another embodiment of the present invention. The keypad 5c in FIG. 8 has a standard arrangement of keys, wherein the individual keys on keypad 5c have uniform height and non-uniform width. FIG. 8 shows four sequential touch events on a keypad 5c. The touch events 1 to 4 are denoted by a cross 1, a circle 2, a hexagon 3 and triangle 4. Consequently, the Personal Identification Number (PIN) associated with FIG. 8 is “1247”. Relative to the display 6, the spatial positions of the touch events in FIG. 8 and FIG. 3 are identical but the resulting PIN entered in FIG. 8 and FIG. 3 is different. As demonstrated by FIG. 3 and FIG. 8, by changing the shape and size of a keypad with a standard arrangement of keys, a third party is not able to unambiguously discern the PIN entered via the pattern of keystrokes.

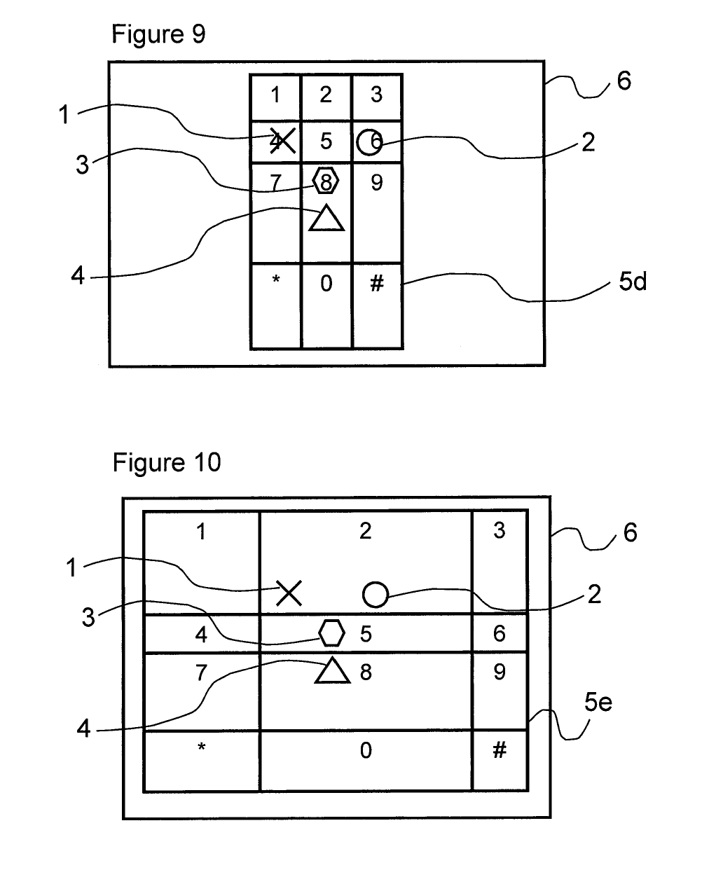

FIG. 9 shows a keypad 5d displayed on an information display 6 that has a touchscreen and a privacy function in accordance with another embodiment of the present invention. The keypad 5d in FIG. 9 has a standard arrangement of keys, wherein the individual keys on keypad 5d have non-uniform height and uniform width. FIG. 9 shows four sequential touch events on a keypad 5d. The touch events 1 to 4 are denoted by a cross 1, a circle 2, a hexagon 3 and triangle 4. Consequently, the Personal Identification Number (PIN) associated with FIG. 9 is “4688”. Relative to the display 6, the spatial positions of the touch events in FIG. 9 and FIG. 3 are identical but the resulting PIN entered in FIG. 9 and FIG. 3 is different. As demonstrated by FIG. 3 and FIG. 9, by changing the shape and size of a keypad with a standard arrangement of keys, a third party is not able to unambiguously discern the PIN entered via the pattern of keystrokes.

FIG. 10 shows a keypad 5e displayed on an information display 6 that has a touchscreen and a privacy function in accordance with another embodiment of the present invention. The keypad 5e in FIG. 10 has a standard arrangement of keys, wherein the individual keys on keypad 5e have non-uniform height and non-uniform width. FIG. 10 shows four sequential touch events on a keypad 5e. The touch events 1 to 4 are denoted by a cross 1, a circle 2, a hexagon 3 and triangle 4. Consequently, the Personal Identification Number (PIN) associated with FIG. 10 is “2258”. Relative to the display 6, the spatial positions of the touch events in FIG. 10 and FIG. 3 are identical but the resulting PIN entered in FIG. 10 and FIG. 3 is different. As demonstrated by FIG. 3 and FIG. 10, by changing the shape and size of a keypad with a standard arrangement of keys, a third party is not able to unambiguously discern the PIN entered via the pattern of keystrokes.

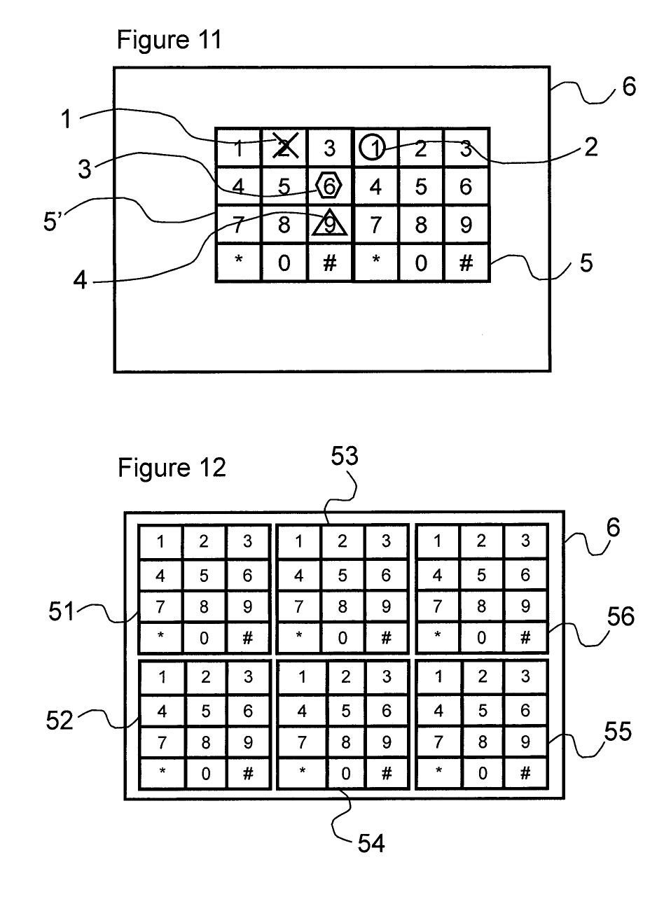

FIG. 11 shows two identical keypads 5 and 5′ displayed on an information display 6 that has a touchscreen and a privacy function in accordance with another embodiment of the present invention. Both keypads 5 and 5′ in FIG. 11 have a standard arrangement of keys. The individual keys on keypads 5 and 5′ have uniform height and uniform width, and have an aspect ratio whereby the key width is equal to the key height. FIG. 11 shows four sequential touch events that utilize both keypads 5 and 5′. The touch events 1 to 4 are denoted by a cross 1, a circle 2, a hexagon 3 and triangle 4. Consequently, the Personal Identification Number (PIN) associated with FIG. 11 is “2169”. In order to form the PIN “2169” in FIG. 11, the key entries “2”, “6” and “9” are derived from keypad 5′ while the key entry “1” is derived from keypad 5. Relative to the display 6, the spatial positions of the touch events in FIG. 11 and FIG. 3 are identical but the resulting PIN entered in FIG. 11 and FIG. 3 is different. As demonstrated by FIG. 3 and FIG. 11, displaying multiple copies of the same keypad enable the user to input the same PIN in multiple different ways. Consequently, multiple keypads with a standard arrangement of keys prevent a third party from unambiguously discerning the PIN entered via the pattern of keystrokes.

FIG. 12 shows six identical keypads 51, 52, 53, 54, 55 and 56 displayed on an information display 6 that has a touchscreen and a privacy function in accordance with another embodiment of the present invention. All keypads 51, 52, 53, 54, 55 and 56 in FIG. 12 have a standard arrangement of keys. The individual keys on keypads 51, 52, 53, 54, 55 and 56 have uniform height and uniform width, and have an aspect ratio whereby the key width is equal to the key height. If the user is free to input a PIN by utilizing keys from any of the keypads 51, 52, 53, 54, 55 and 56, the user has multiple ways in which to input a PIN. As demonstrated by FIG. 3 and FIG. 12, displaying multiple copies of the same keypad enable the user to input the same PIN in multiple different ways. In general, if there are m keypads displayed upon an information display, and n numbers within a PIN, then the number of ways of entering the PIN is mⁿ (m to the power n). Consequently, multiple keypads with a standard arrangement of keys prevent a third party from unambiguously discerning the PIN entered via the pattern of keystrokes.

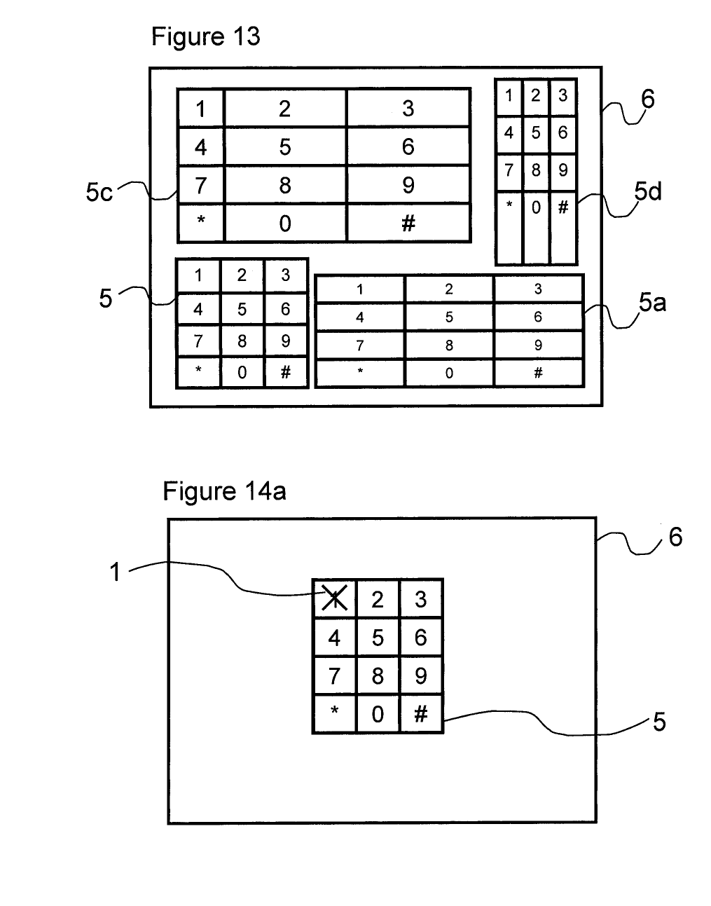

FIG. 13 shows four non-identical keypads 5, 5a, 5c and 5d displayed on an information display 6 that has a touchscreen and a privacy function in accordance with an embodiment of the present invention. All keypads 5, 5a, 5c and 5d in FIG. 13 have a standard arrangement of keys. If the user is free to input a PIN by utilizing keys from any of the keypads 5, 5a, 5c and 5d, the user has multiple ways in which to input a PIN. As demonstrated by FIG. 3 and FIG. 13, displaying multiple copies of the same keypad enable the user to input the same PIN in multiple different ways. Consequently, multiple keypads with a standard arrangement of keys prevent a third party from unambiguously discerning the PIN entered via the pattern of keystrokes. For PIN entry in general, any number of keypads of any type 5, 5a, 5b, 5c, 5d and 5e can be displayed on an information display 6 that has a privacy function in accordance with the present invention and touchscreen.

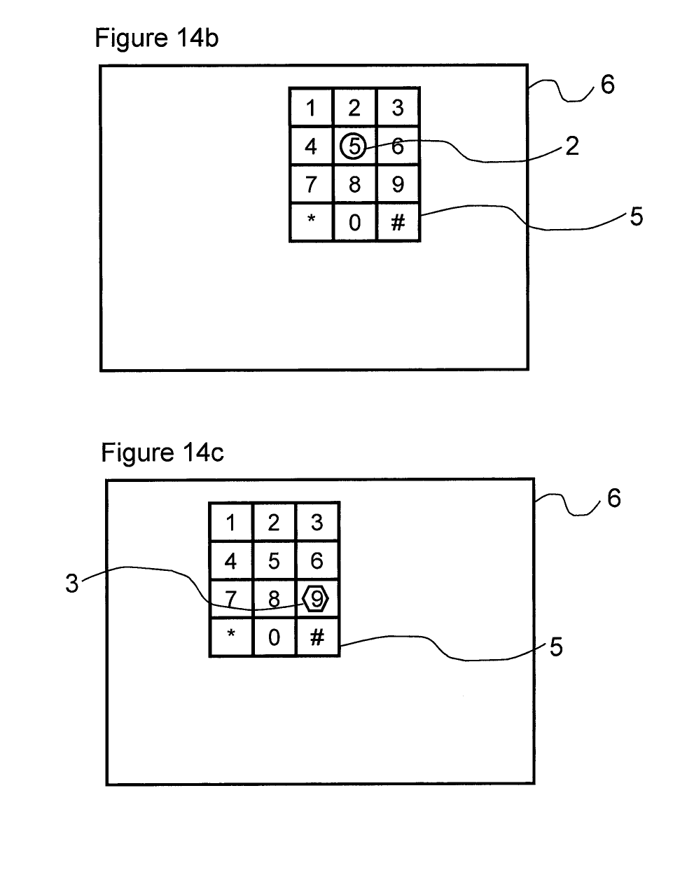

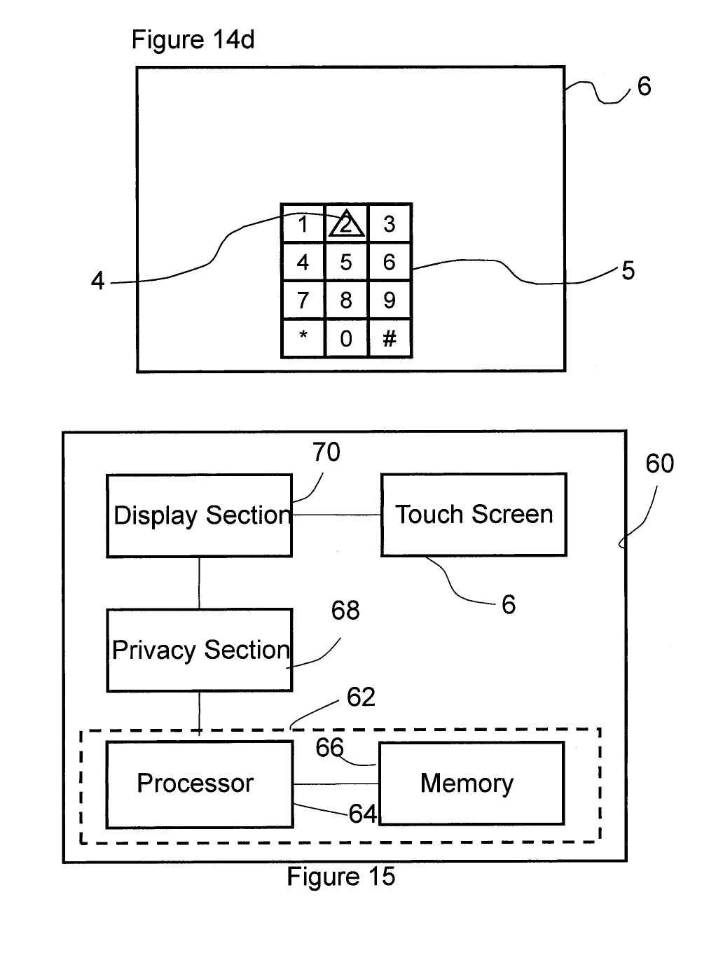

FIG. 14a, FIG. 14b, FIG. 14c and FIG. 14d show a keypad 5 displayed on an information display 6 that has a touchscreen and a privacy function in accordance with another embodiment of the present invention. The keypad 5 in FIG. 14a, FIG. 14b, FIG. 14c and FIG. 14d has a standard arrangement of keys, wherein the individual keys on keypad 5 have uniform height and uniform width. FIG. 14a, FIG. 14b, FIG. 14c and FIG. 14d show four sequential touch events on a keypad 5. The first touch event is depicted on FIG. 14a with a cross 1, the second touch event is depicted on FIG. 14b with a circle 2, the third touch event is depicted on FIG. 14c with a hexagon 3, and the fourth touch event is depicted on FIG. 14d with a triangle 4. Consequently, the Personal Identification Number (PIN) associated with FIG. 14a, FIG. 14b, FIG. 14c and FIG. 14d is “1592”. Relative to the display 6, the spatial positions of the touch events in FIG. 14a, FIG. 14b, FIG. 14c and FIG. 14d and FIG. 3 are identical but the resulting PIN entered in FIG. 14 and FIG. 3 is different. As demonstrated by FIG. 3 and FIG. 14, by changing the position of a keypad between keystrokes, a third party is not able to unambiguously discern the PIN entered via the pattern keystrokes. Any keypad 5a, 5b, 5c, 5d and/or 5e may replace the use of keypad 5 as depicted FIG. 14a, FIG. 14b, FIG. 14c and/or FIG. 14d. In general, the keypad size, position or shape may change between none, one or more than one of the user's keystrokes.

The embodiments illustrated in FIG. 3-14 depict various methods for enhancing the privacy of PIN entry. The exact method for PIN entry, for example, may be different for each user, chosen at random by the machine requiring PIN entry, pre-defined by the user and/or pre-defined by the payment card associated with the PIN.

With reference to the embodiments described herein, there is a trade-off between user acceptability of a private data entry system and the degree of added security provided by the private data entry system. At one extreme, the data entry system is unchanged and consequently there are no user acceptance issues. At the other extreme, a data entry system that is very secure is also complex to use and so user acceptance is low. Embodiments described herein cover various different trade-off levels between user acceptability and the degree of added security for private data entry. The best mode of operation therefore depends upon the nature of the application and consequently the trade-off point between user acceptability and the degree of added security.

An example of a private data entry system that has very high user acceptance and relatively low added security involves using the same design of keypad for all users and simply translating the position of the keypad to a random spatial location upon the display 6. This high user acceptance/low added security private data entry system is illustrated in FIG. 3 and FIG. 4 and is described herein.

An example of a private data entry system that has relatively low user acceptance and very high added security involves using a different keypad type (i.e. a keypad type as shown in FIG. 3, FIG. 5, FIG. 6, FIG. 7, FIG. 8, FIG. 9 and FIG. 10) of random size for each keystroke. The spatial location of each keypad upon the display 6 is also chosen at random.

Referring now to FIG. 15, there is shown a simple block diagram of an exemplary privacy device 60 in accordance with the present invention. As described herein, the privacy device 60 can be used to enter private information, such as personal identification numbers or the like, prior to accessing other private information. Although not shown, the privacy device 60 may be communicatively coupled to other electronic devices, such as a central server, for example, for communicating information there between as is conventional. The privacy device 60 includes a processing section 62 for executing instructions, the processing section comprising a processor 64 (e.g., a CPU, microcontroller or microprocessor) and a memory 66 (e.g., volatile and non-volatile RAM, ROM, magnetic, etc.) for storing computer executable code and data related to executing such code.

When executed by the processor 64, the computer executable code causes the processor 64 to generate data corresponding to a graphical user interface. The graphical user interface, for example, can be a numeric or alpha-numeric key or the like as shown and described herein. The user interface data generated by the processing section 62 is provided to a privacy section 68 in accordance with the present invention, wherein the privacy section 68 is configured to implement a privacy function that prevents an unauthorized party from indirectly ascertaining user-entered information. For example, and as disclosed herein, the privacy section 68 may alter at least one characteristic of the user interface as displayed on the touchscreen such that a plurality of input zones on the graphical user interface varies with respect to touch cells of the touch screen (e.g., by altering a width or height of input zones on the user interface, randomly moving the user interface after each data entry, creating multiple user interfaces that are simultaneously displayed on the touchscreen, etc.). Such alterations can be accomplished by manipulating the user interface data provided by the processing section 62. The altered user interface data from the privacy section 68 then is provided to a display section 70, which conditions the data for use by a touchscreen 6. The touchscreen 6 then displays the altered user interface.

The functions provided by the privacy section 68 can be implemented in hardware, e.g., via dedicated circuitry, software (e.g., software executed by the processing section 62) or a combination of hardware and software. Accordingly, reference to a “privacy section” includes a hardware circuit, a software function, or combination thereof.

It will be apparent to a person having ordinary skill in the art of computer programming, and specifically in applications programming for data entry devices or other items of electronic equipment, how to program an electronic device to operate and carry out the functions described herein. Accordingly, details as to the specific programming code have been left out for sake of brevity.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A device for privately entering data, comprising:
a touchscreen having a plurality of touch cells for inputting data;
a processor section configured to generate a graphical user interface for display on the touchscreen for a predefined operation, the graphical user interface including a plurality of input zones; and
a privacy section operatively coupled to the processor section and to the touchscreen, the privacy section configured to alter a characteristic of the graphical user interface as displayed on the touchscreen for the predefined operation in order to change the touch cells associated with the graphical user interface.

2. The device according to claim 1, wherein the graphical user interface is a key pad.

3. The device according to claim 1, wherein the privacy section is configured to vary a spatial location of the user interface on the touchscreen.

4. The device according to claim 1, wherein the privacy section is configured to vary an aspect ratio of each input zone.

5. The device according to claim 4, wherein the privacy section is configured to form a width of each input zone to be greater than a height of each input zone.

6. The device according to claim 4, wherein the privacy section is configured to form a height of each input zone to be greater than a width of each input zone.

7. The device according to claim 1, wherein the privacy section is configured to form at least one of non-uniform height or non-uniform width between at least two input zones of the plurality of input zones.

8. The device according to claim 1, wherein the privacy section is configured to generate a plurality of user interfaces having the same input zones, the plurality of user interfaces arranged such that when displayed on the touchscreen each input zone of the respective plurality of user interfaces corresponds to a different touch cell of the touchscreen.

9. A device for privately entering data, comprising:
a touchscreen having a plurality of touch cells for inputting data:
a privacy section configured to generate a plurality of graphical user interfaces for entering the private data, each graphical user interface comprising substantially the same input functions; and
a display section configured to simultaneously display the multiple graphical user interfaces on the touchscreen.

10. The device according to claim 8, wherein the plurality of user interfaces are graphically different from one another.

11. The device according to claim 8, wherein the privacy section is configured to select different ones of the plurality of user interfaces for each data entry.

12. The device according to claim 1, wherein the privacy section is configured to vary a location of the user interface on the touchscreen after each data entry.

13. The device according to claim 1, wherein altering the graphical user interface includes at least one of randomly altering the user interface, altering the user interface based on user identity, altering the user interface based on user preference, or altering the user interface based on operator preference.

14. The device according to claim 1, wherein the privacy section is configured to change at least one of a size, shape, or position of the user interface between at least two data entries on the touchscreen.

15. The device according to claim 1, wherein the touchscreen comprises a privacy device that prevents viewing of the screen at an angle greater than a predetermined angle normal to a surface of the touchscreen.

16. The device according to claim 1, wherein the processor section configures the plurality of input zones to correspond to a first group of touch cells of the plurality of touch cells, and the privacy section reconfigures the input zones to correspond to a second group of touch cells of the plurality of touch cells, the second group of touch cells different from the first group of touch cells.

17. A method for creating a private entry display on a touchscreen, said touchscreen including a plurality of touch cells corresponding to spatial locations on the touchscreen, the method comprising:
generating a graphical user interface for display on the touchscreen for a predefined operation, the graphical user interface including a plurality of input zones;
altering a characteristic of the graphical user interface as displayed on the touchscreen for the predefined operation in order to change the touch cells associated with the graphical user interface; and
displaying the altered user interface on the touchscreen.

18. The method according to claim 17, wherein generating a graphical user interface includes generating the graphical user interface as a key pad.

19. The method according to claim 17, wherein altering the characteristic of the graphical user interface includes varying a spatial location of the user interface on the touchscreen.

20. The method according to claim 17, wherein altering characteristic of the graphical user interface includes varying an aspect ratio of each input zone.

21. The method according to claim 20, wherein varying an aspect ratio of each input zone includes forming a width of each input zone to be greater than a height of each input zone.

22. The method according to claim 20, wherein varying an aspect ratio of each input zone includes forming a height of each input zone to be greater than a width of each input zone.

23. The method according to claim 17, wherein altering the characteristic of the graphical user interface includes varying at least one of an input zone width or an input zone height between at least two input zones of the plurality of input zones.

24. The method according to claim 17, wherein altering the characteristic of the graphical user interface includes creating a plurality of user interfaces having the same input zones, and displaying each of the plurality of user interfaces on different portions of the touchscreen such that each input zone of the respective plurality of user interfaces corresponds to a different touch cell of the touchscreen.

25. A method for entering private data on a touchscreen, said private data including at least two input data, the method comprising:
generating a plurality of graphical user interfaces for entering the private data, each graphical user interface comprising substantially the same input functions;
simultaneously displaying the plurality of graphical user interfaces on the touchscreen;
using the input function of one of the plurality of graphical user interfaces to enter one of the at least two input data; and
using the input function of a different one of the plurality of graphical user interfaces to enter the other of the at least two input data.

26. The method according to claim 24, further comprising generating the plurality of user interfaces such that they are different from one another.

27. The method according to claim 24, further comprising entering data on different ones of the plurality of user interfaces.

28. The device according to claim 17, further comprising varying a location of the user interface on the touchscreen after each data entry.

29. The method according to claim 17, further comprising changing at least one of a size, shape, or position of the user interface between at least two data entries on the touchscreen.

30. The method according to claim 17, further comprising preventing the screen from being viewed at an angle greater than a predetermined angle normal to a surface of the touchscreen.

31. The method according to claim 17, wherein altering the characteristic of the graphical user interface includes at least one of randomly selecting the attribute to be altered, selecting the attribute to be altered based on a user identification, selecting the attribute to be altered based on a pre-defined user preference, or selecting the attribute to be altered based on a pre-defined operator preference.

32. The method according to claim 17, wherein generating the graphical user interface includes configuring the plurality of input zones to correspond to a first group of touch cells of the plurality of touch cells, and wherein altering the characteristic of the graphical user interface includes reconfiguring the input zones to correspond to a second group of touch cells of the plurality of touch cells, the second group of touch cells different from the first group of touch cells.
